(19) United States
(12) Patent Application Publication
(10) Pub. No.: US 2006/0262556 A1
(43) Pub. Date: Nov. 23, 2006

(54) Backlight module with heat dissipation members

(75) Inventor: Ying Zeng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/439,056

(22) Filed: May 23, 2006

(30) Foreign Application Priority Data
May 23, 2005 (TW) 94208352

(51) Int. Cl. F21V 29/00; F21V 7/04

(52) U.S. Cl. 362/600; 362/373

(57) ABSTRACT

A backlight module (2) includes a light illuminating device (20), and a light guide plate (21). The light illuminating device includes a light source (201) with two light contacts (2011) at opposite ends thereof, and a pair of heat dissipation members (202) disposed at the opposite ends of the light source and engaged with the light contacts. The light guide plate (21) includes an incident side (212), wherein the light illuminating device is disposed adjacent the incident side of the light guide plate.

### FIELD OF THE INVENTION

The present invention relates to backlight modules, and more particularly to backlight modules for use in liquid crystal displays or the like.

### BACKGROUND

Liquid crystal displays (LCDs) have become widely used in various electronic devices because of their high luminance, good display quality, large display area, and thin profile. A typical LCD mainly includes a backlight module and a liquid crystal panel. In general, the backlight module needs to provide high luminance light in order to properly illuminate the liquid crystal panel of the LCD.

The backlight module mainly includes a light source and a light guide plate. A cold cathode fluorescent lamp (CCFL) is commonly used as the light source. The CCFL is a sealed tube normally including argon (Ar) or neon (Ne) gas, and further including mercury (Hg) gas. An inner wall of the tube is coated with fluorescent material. When the CCFL electrically discharges, the mercury gas radiates ultraviolet rays, and the ultraviolet light rays strike the fluorescent material and generate visible light rays.

The light guide plate cooperates with the light source to illuminate an entire display area of the LCD. On the one hand, an LCD with a small sized screen requires a light guide plate and only a single light source. On the other hand, an LCD with a large sized screen often requires a light guide plate and more than one light source.

Referring to FIGS. 9 and 10, a conventional LCD includes a backlight module 1, a liquid crystal panel 11, and a shield 13. The backlight module 1 generates a predetermined luminance that illuminates the liquid crystal panel 11. The liquid crystal panel 11 is contained within the shield 13.

The backlight module 1 also includes two cold cathode fluorescent lamps used as light sources 10, four light source holders 12 engaged with the light sources 10 at corners of the liquid crystal panel 11 respectively, a light guide plate 14 sandwiched between the light sources 10 for guiding light beams emitted by the light sources 10 into the liquid crystal panel 11, and two frame holders 16 engaged with the light source holders 12.

Also referring to FIG. 11, each light source 10 has two respective of the light source holders 12 disposed at opposite ends thereof. Each of these light source holders 12 is securing by the corresponding frame holder 16. The light source holders 12 are situated in the vicinity of the light guide plate 14, and face the light guide plate 14 directly. When power is supplied to the light source 10, the light source 10 emits heat as well as light. The light source 10 includes two light contacts at opposite ends thereof respectively, where the respective light source holders 12 are located. The temperature generated in the vicinity of the light contacts is particularly high. The heat generated by the light source 10 is transferred to the light guide plate 14 via the light source holders 12. When the supply current is increased to obtain a higher luminance of the light source 10, the temperature at the light source holders 12 can become as high as 120° C. or even higher. Thus there is a risk of adjacent portions of the light guide plate 14 melting. If the light guide plate 14 is deformed or deteriorated by melting adjacent both the light sources 10, the light emitted from the light sources 10 cannot be guided properly by the light guide plate 14. This results in decreased luminance and resolution of the display provided by the liquid crystal panel 11.

In order to overcome the above-described problems, another kind of backlight module similar to the backlight module 1 has been developed. FIG. 12 shows some parts of such backlight module. The backlight module includes a heat dissipation member 35 with a generally L-shaped structure. The heat dissipation member 35 has a first heat release part 351 and a second heat release part 352, and is bonded to a corresponding corner part 341 of a light guide plate 34 by double-faced adhesive tape (not shown). Thus the first heat release part 351 of the heat dissipation member 35 is disposed at a side of the light guide plate 34 that is adjacent to an incident side 342 of the light guide plate 34, while the second heat release part 352 of the heat dissipation member 35 is disposed on the incident side 342 itself of the light guide plate 34. Accordingly, the light guide plate 34 and the heat dissipation member 35 are both held by the light source holder 32, with the heat dissipation member 35 being disposed generally between the light guide plate 34 and the light source holder 32.

When power is supplied to a light source 30 engaged with the light source holder 32, heat generated by the light source 30 tends to accumulate in the vicinity of a light contact that is located at an end of the light source 30 in the light source holder 32. The heat generated by the light source 30 transmits to the heat dissipation member 35 via the light source holder 32.

However, because of the need to have the second heat release part 352 of the heat dissipation member 35 disposed between the incident side 342 of the light guide plate 34 and the light source holder 32, the gap between the incident side 342 and the light source 30 is larger than it would otherwise be. In addition, the heat dissipation member 35 including the second heat release part 352 is opaque. Therefore the amount of light emitted from the light source 30 which enters the light guide plate 34 is reduced. Thus the luminance provided by the backlight module to the associated liquid crystal panel is correspondingly reduced.

Accordingly, what is needed is a backlight module that can overcome the above-described deficiencies.

### SUMMARY

An exemplary backlight module includes a light illuminating device, and a light guide plate. The light illuminating device includes a light source with two light contacts at opposite ends thereof, and a pair of heat dissipation members disposed at the opposite ends of the light source and engaged with the light contacts. The light guide plate includes an incident side, wherein the light illuminating device is disposed adjacent the incident side of the light guide plate.

Another backlight module includes a light illuminating device, and a light guide plate. The light illuminating device includes a light source with two light contacts at opposite ends thereof, and a pair of heat dissipation members with a plurality of recesses disposed at the opposite ends of the light source and engaged with the light contacts. The light guide plate includes an incident side, wherein the light illuminating device is disposed adjacent the incident side of the light guide plate.

Comparing to the prior art, the back light module above-mentioned releases the heat emitted by the light source more efficiently by increasing the surface of the heat dissipation members, and avoiding the luminance and resolution of the display decreased causes by the heat accumulated in the vicinity of the light contact.

A detailed description is given in the following embodiments with reference to the accompanying drawings.

### BRIEF DESCRIPTION OF THE DRAWINGS

Embodiments of the invention can be more fully understood by reading the subsequent detailed description and examples with references made to the accompanying drawings, wherein:

FIG. 1 is a schematic, isometric view of a backlight module according to a first embodiment of the present invention;

FIG. 2 is an exploded view of the backlight module shown in FIG. 1;

FIG. 3 is a schematic, cross-sectional view taken along line III-III of FIG. 1, showing details of one of light illuminating devices employed in the backlight module;

FIG. 4 is an enlarged view of a circled portion IV of FIG. 2, showing a heat dissipation member of the same light illuminating device as that shown in detail in FIG. 3;

FIG. 5 is similar to FIG. 4, but showing a heat dissipation member employed in a backlight module according to a second embodiment of the present invention;

FIG. 6 is similar to FIG. 4, but showing a heat dissipation member employed in a backlight module according to a third embodiment of the present invention;

FIG. 7 is similar to FIG. 4, but showing a heat dissipation member employed in a backlight module according to a fourth embodiment of the present invention;

FIG. 8 is similar to FIG. 4, but showing a heat dissipation member employed in a backlight module according to a fifth embodiment of the present invention;

FIG. 9 is a schematic, top plan view of a conventional LCD;

FIG. 10 is a schematic, right side plan view of the LCD of FIG. 9;

FIG. 11 is an enlarged view of a circled portion XI of FIG. 9, showing a light source holder sandwiched between a frame holder and a light guide plate; and

FIG. 12 is similar to FIG. 11, but showing parts of another conventional LCD, wherein a heat dissipation member is sandwiched between a light source holder and a light guide plate.

### DETAILED DESCRIPTION OF PREFERRED EMBODIMENTS

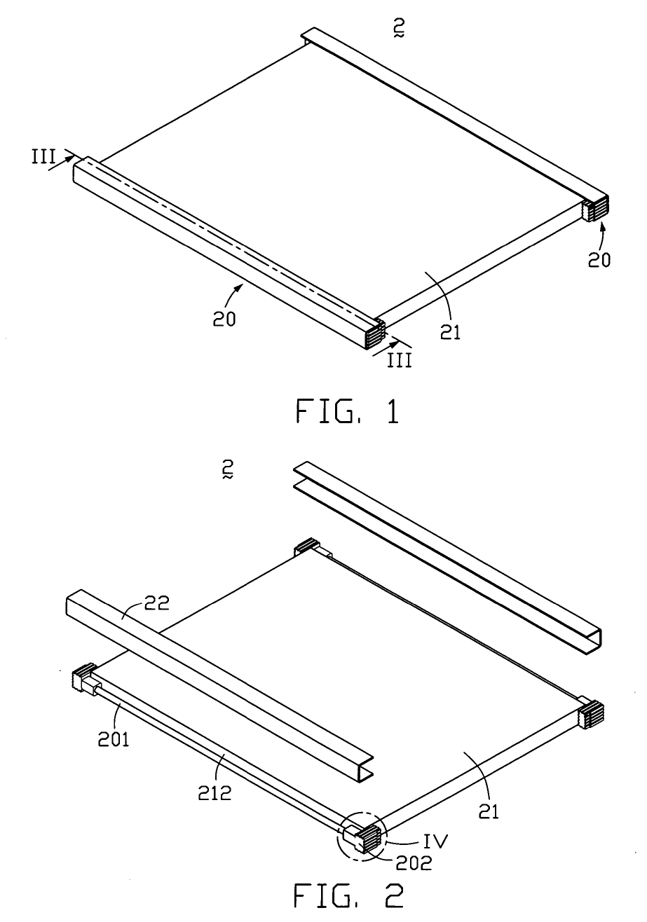

Referring to FIG. 1, a backlight module 2 includes two light illuminating devices 20, and a light guide plate 21 sandwiched between the light illuminating devices 20.

Referring also to FIG. 2, the light guide plate 21 is an acrylic resin sheet for guiding light emitted from the light illuminating devices 20. In particular, the light guide plate 21 has a pair of opposite incident sides 212 that respectively face the light illuminating devices 20. Each light illuminating device 20 includes a light source 201, a pair of heat dissipation members 202, and a light source holder 22. The light source holder 22 is made of metal such as aluminum or copper, and extends substantially a same length as the light source 201. The light source holder 22 secures the light source 201 and the heat dissipation members 202 at the opposite ends of the light source 201 and a corresponding side of the light guide plate 21. Thus the light guide plate 21 is located between the two light sources 201 of the two light illuminating devices 20. An inner surface of the light source holder 22 of each light illuminating device 20 is coated with a reflective layer, for reflecting light emitted from the light source 201 into the light guide plate 21 and thereby reducing light dissipation and wastage.

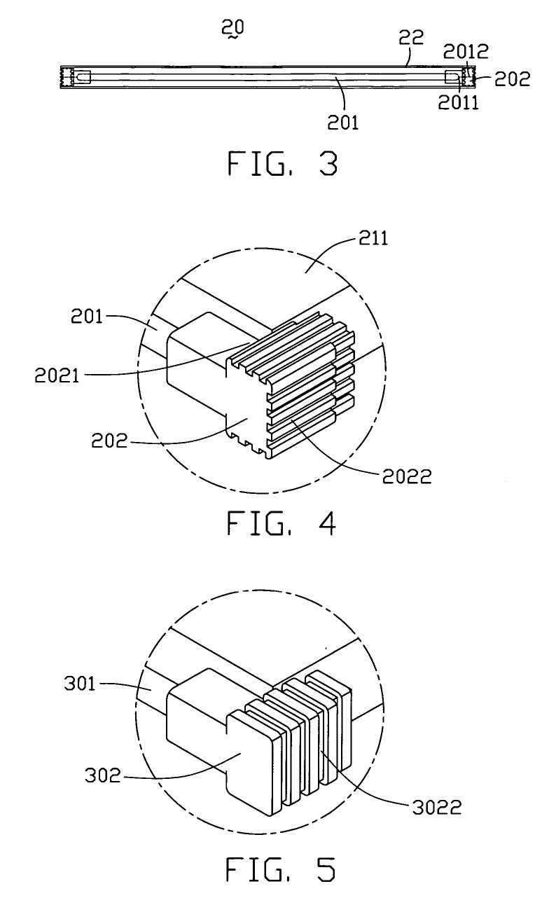

Referring also to FIG. 3, each light source 201 is typically a CCFL. A pair of light contacts 2011 is formed at opposite ends of the light source 201 respectively. Two wires 2012 are connected to the light contacts 2011 respectively, and extend outward for conducting power to the light source 201. When the wires 33 are energized, the light contacts 2011 electrically discharge, and the light source 201 generates visible light rays.

Each heat dissipation member 202 includes highly conductive metal particles or heat dissipation grease filled therein, for achieving high heat conductivity. Two of the heat dissipation members 202 are disposed at the opposite ends of the corresponding light source 201 and engaged with the corresponding light contacts 2011 thereat, and are thereby firmly secured to the light source 201. Heat generated by the light source 201 transmits to the heat dissipation members 202 and is then dissipated to the ambient environment.

As seen in FIG. 2, the four heat dissipation members 202 are disposed at four corners of the light guide plate 21 respectively and directly abut the light guide plate 21. Referring to FIG. 4, each heat dissipation member 202 has an L-shaped step part 2021 engaged with a corresponding corner part 211 of the light guide plate 21. A section of the step part 2021 in the vicinity of the light source 201 abuts the corresponding incident side 212 of the light guide plate 21, and another section of the step part 2021 distal from the light source 201 abuts a side of the light guide plate 21 that is adjacent to the incident side 212.

A plurality of parallel, elongate grooves 2022 is defined in surfaces of each heat dissipation member 202, for increasing a total heat dissipating surface of the heat dissipation member 202. The grooves are located at surfaces of the step part 2021 that are distal from the light source 201. Each of the grooves 2022 is aligned in a horizontal plane.

A large amount of heat is generated in the vicinity of the light contact 2011 within each heat dissipation member 202. The heat transmits to the heat dissipation member 202, and much of the heat is dissipated to the ambient environment via the grooves 2022. Thereby, accumulation of heat at the corresponding corner part 211 corner part 211 of the light guide plate 21 can be avoided. Further, it is to be understood that the grooves 2022 are not limited to being aligned as described above, but can be aligned along any desired one or more directions.

For example, referring to FIG. 5, this shows another kind of heat dissipation member 302. The heat dissipation member 302 is similar to the heat dissipation member 202. However, the heat dissipation member 302 has a plurality of grooves 3022, each of which is aligned in a vertical plane.

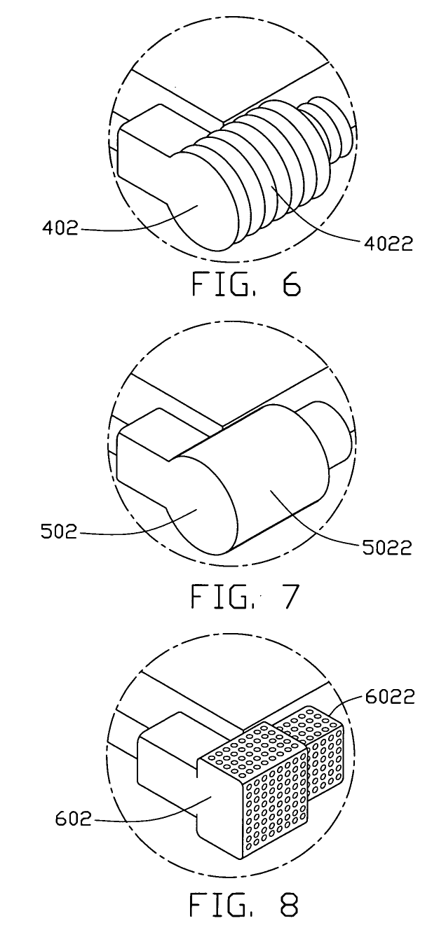

Referring to FIG. 6, this shows another kind of heat dissipation member 402. The heat dissipation member 402 is similar to the heat dissipation member 202. However, a portion of the heat dissipation member 402 distal from the corresponding light source (not labeled) is generally bicylindrical. A plurality of generally annular grooves 4022 is defined in the bicylindrical portion of the heat dissipation member 402.

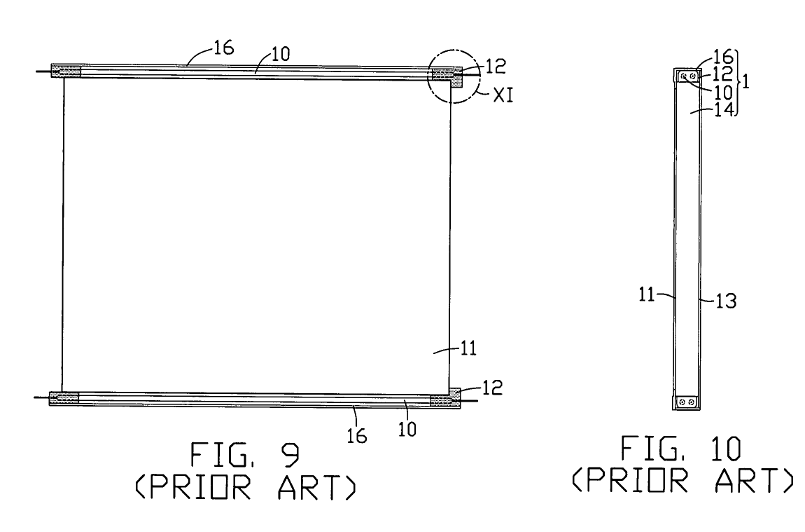

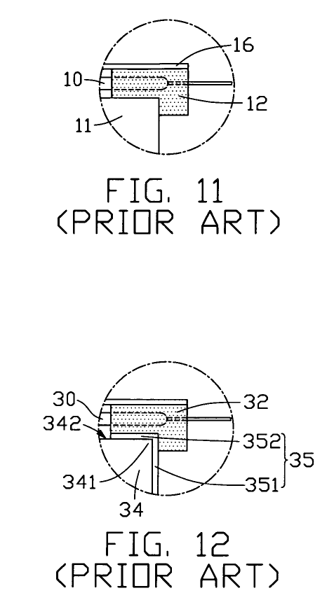

By providing the plurality of grooves 2022, 3022, 4022, the surface areas of the heat dissipation members 202, 302, 402 are substantially increased, thereby allowing more effective release of heat and preventing accumulation of heat. The surfaces of the heat dissipation members 202, 302, 402 can alternatively have various other kinds of configurations, among which are exemplary structures such as those shown in FIG. 7 and FIG. 8.

Referring to FIG. 7, this shows another kind of heat dissipation member 502. The heat dissipation member 502 is similar to the heat dissipation member 402. However, a portion of the heat dissipation member 502 distal from the corresponding light contacts 2011 has a generally smooth bicylindrical surface 5022.

Referring to FIG. 8, this shows another kind of heat dissipation member 602. The heat dissipation member 602 is similar to the heat dissipation member 202. However, a portion of the heat dissipation member 602 has a surface 6022 with a plurality of recesses or pits.

In other alternative embodiments, the curved-shape surface 5022 can be applied to and/or combined with any one or more of the surfaces and/or configurations of any one or more of the heat dissipation members 202, 302, 402, 602. Similarly, the recessed or pitted surface 6022 can be applied to and/or combined with any one or more of the surfaces and/or configurations of the heat dissipation members 202, 302, 402, 602. With any of such various embodiments, the overall surface area of the heat dissipation member 202, 302, 402, 502, 602 is increased, for allowing more efficient dissipation of heat therefrom.

While preferred and exemplary embodiments have been described by way of example above, it is to be understood that embodiments of the invention are not limited thereto. To the contrary, embodiments of the invention are intended to also cover various modifications and similar arrangements (as would be apparent to those skilled in the art). Therefore, the scope of the appended claims should be accorded the broadest interpretation so as to encompass all such modifications and similar arrangements.

What is claimed is:

1. A backlight module, comprising:
a light illuminating device comprising:
a light source with two light contacts at opposite ends thereof; and
a pair of heat dissipation members disposed at the opposite ends of the light source and engaged with the light contacts; and
a light guide plate having an incident side, wherein the light illuminating device is disposed adjacent the incident side of the light guide plate.

2. The backlight module as claimed in claim 1, wherein a portion of each of the heat dissipation members distal from the corresponding light contact is curved.

3. The backlight module as claimed in claim 1, wherein a surface of the heat dissipation member has a plurality of recesses.

4. The backlight module as claimed in claim 1, wherein a portion of each of the heat dissipation members distal from the corresponding light contact has a plurality of grooves.

5. The backlight module as claimed in claim 1, wherein each of the heat dissipation members comprises an L-shaped step part abutting against an adjacent corner of the light guide plate.

6. The backlight module as claimed in claim 1, further comprising a light source holder engaged with the heat dissipation members.

7. The backlight module as claimed in claim 6, wherein an inner surface of the light source holder is coated with a reflective layer.

8. A backlight module, comprising:
an illuminating device comprising a light source with two light contacts at opposite ends thereof and a pair of heat dissipation members with a plurality of recesses, wherein the heat dissipation members are disposed at the opposite ends of the light source and engaged with the light contacts; and
a light guide plate having an incident side, wherein the light illuminating device is disposed adjacent the incident side of the light guide plate.

9. The backlight module as claimed in claim 8, wherein each of the heat dissipation members has an L-shaped step part abutting against an adjacent corner of the light guide plate.

10. The backlight module as claimed in claim 8, further comprising a light source holder engaged with the heat dissipation members.

11. The backlight module as claimed in claim 10, wherein an inner surface of the light source holder is coated with a reflective layer.
